(19) United States
(12) Patent Application Publication
(10) Pub. No.: US 2010/0180507 A1
(43) Pub. Date: Jul. 22, 2010

(54) SLIDING DOOR

(76) Inventor: Reinhard Puchebner, Amstetten (AT)

Correspondence Address: BARNES & THORNBURG LLP, 750-17TH STREET NW, SUITE 900, WASHINGTON, DC, 20006-4675, US

(21) Appl. No.: 12/667,498

(22) PCT Filed: Jul. 30, 2008
(86) PCT No.: PCT/EP08/06287

§ 371 Date: Dec. 31, 2009

(30) Foreign Application Priority Data
Jul. 31, 2007 (AT) A 1202007

(51) Int. Cl. E05D 15/58; B60J 5/00

(52) U.S. Cl. 49/226

(57) ABSTRACT

A sliding door or swinging sliding door for vehicles, the sliding door or swinging sliding door including a guide located in a lower region of a gantry and a door leaf including a guide part located in a lower region of the door leaf. The guide part projects into the guide. The door leaf further includes a reinforcement plate covering the lower region of the door leaf. The reinforcement plate and the guide part are integrated into a single component.

### CROSS-REFERENCE TO RELATED APPLICATIONS

This application is a National Phase Application based upon and claiming the benefit of priority to PCT/EP2008/006287, filed on Jul. 30, 2008, which is based upon and claims the benefit of priority to Austrian Patent Application No. AU 1202/2007, filed on Jul. 31, 2007, the contents of both of which are incorporated herein by reference.

### BACKGROUND AND SUMMARY

The present disclosure relates to a sliding door or swinging sliding door for vehicles, or lifts and the like. In particular, the present disclosure relates to a sliding or swinging sliding door for rail vehicles. The door includes at least one door leaf, which has, in its lower region, a guide part which projects into a guide which is provided in the lower part of the gantry, and a reinforcement plate which covers the door leaf in the lower region.

The guidance in the lower region of the gantry ensures that the door leaf is guided in the horizontal direction with respect to the door opening and closing movement and at the same time maintains a predefined course.

If the lower part of the door leaf is kicked in, which often occurs, for example, as a result of vandalism, or drink-fuelled riotous behaviour, or actions by extremist groups, such occurrences are increasingly and frequently leading to situations in which the door leaf is destroyed and has to be completely replaced in order to be able to ensure a reliable opening and closing movement again. In order to limit the consequences of such destructive behaviour, it is known to provide a reinforcement plate in the lower region of the door leaf in doors. The reinforcement plate protects the door leaf by virtue of the fact that its robustness allows it to absorb the acting forces and distribute them uniformly.

A disadvantage of such a reinforcement plate, also referred to as a kick plate, is, however, that deformation of the entire lower region of the door leaf, as a result of particularly strong kicks, cannot be prevented. The result is that the sliding movement of the door is adversely affected.

There is, therefore, a need for a solution in which the sliding door or swinging sliding door remains undamaged even under the influence of particularly hard kicks, to the extent that satisfactory operation of the door continues to be ensured. Such a solution is intended to ensure stability and at the same time be cost-effective to manufacture.

The solution, according to the present disclosure, is achieved with a sliding door or swinging sliding door such that, in the lower region of the door leaf, the reinforcement plate merges in one piece into the guide part which projects into the guide.

This solution has the effect that the forces which are applied to the reinforcement plate are transmitted directly into the gantry region which forms the guide. The door leaf itself does not absorb any forces. The shocks are therefore introduced directly into the gantry.

As a result of the solution, according to the present disclosure, the function of the kick plate and that of the guidance of the door leaf are now integrated in a single component. This increases the stability of the structure with respect to the wilful kicks against the lower region of the door leaf and saves costs in terms of the manufacture and installation. In addition, the solution, according to the present disclosure, improves the seal, for example, to protect against moisture, drafts, dirt, and noise between the interior of the coach and the external area.

Other aspects of the present disclosure will become apparent from the following descriptions when considered in conjunction with the accompanying drawings.

### BRIEF DESCRIPTION OF THE DRAWINGS

FIG. 1 shows a sliding door of a rail vehicle as viewed from an inside of the rail vehicle, in accordance with the present disclosure.

FIG. 2 shows a lower gantry region of a door according to the prior art.

FIG. 3 shows a lower gantry region of a door, according to the present disclosure.

### DETAILED DESCRIPTION

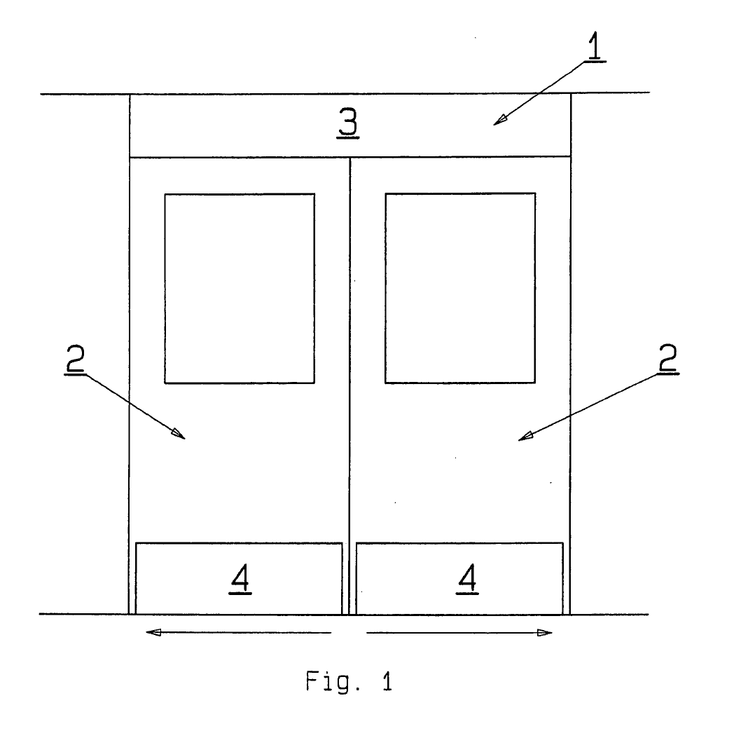

FIG. 1 shows a closed sliding door 1 of a rail vehicle as viewed from an inside of the rail vehicle. When the door 1 opens, door leaves 2 are moved in directions of the illustrated arrows. Usually, a door drive 3 is located above the door leaves 2, while the door leaves 2, in a lower gantry region, are guided in a guide 7. Reinforcement plates 4, also referred to as kick plates, are attached, for example, by screws, to the lower region of the door leaves 2. The reinforcement plates 4 conceal the surface of the door leaves 2 in the lower region and protect the surface against kicks.

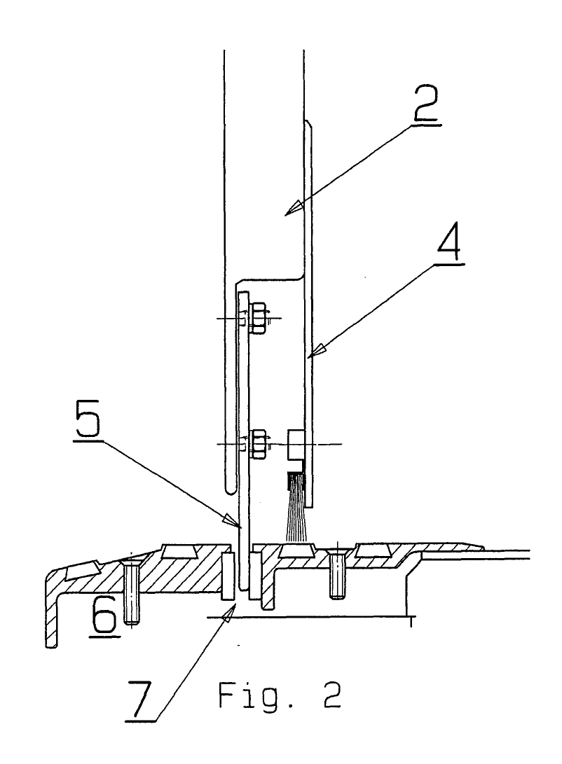

FIG. 2 shows a door, according to the prior art, in which the reinforcement plate 4 is constructed as a separate component. There is no direct connection between the reinforcement plate 4 and guide part 5, and all the forces acting on the reinforcement plate 4 are introduced via the door leaf 2. The door is not sufficiently protected against acts by vandals.

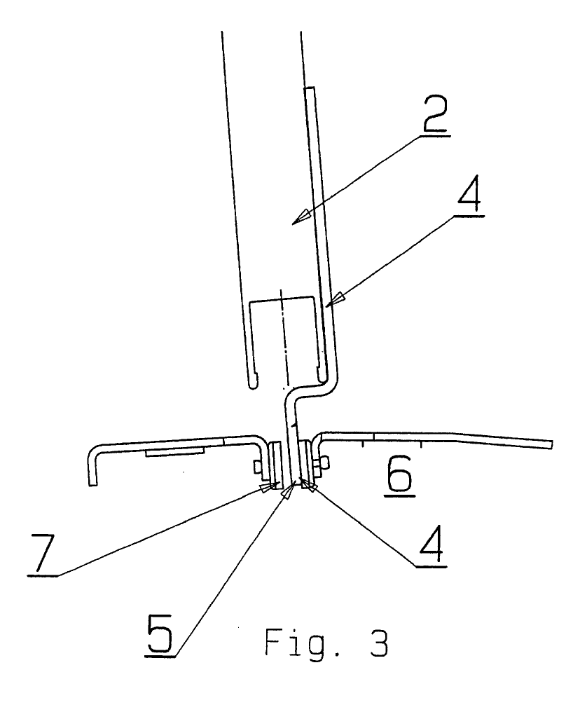

FIG. 3 shows a door leaf 2 in a vertical section and viewed in a direction perpendicular to the plane of the door leaf 2. Arranged on a side of the door leaf 2 facing the interior of the vehicle is a reinforcement plate 4 which extends over a large part of the width of the door leaf 2, for example, essentially along an entire width of the door leaf 2. The kick or reinforcement plate 4 has essentially a rectangular shape and a height of the reinforcement plate 4 may be at least 15 cm, or may be at least 20 cm. The reinforcement plate 4, which is attached in the lower region of the door leaf 2, continues underneath the door leaf 2 and merges integrally with a guide part 5 which projects into a guide 7 in the lower gantry region or in the floor 6 and is in the form of a rail.

The guide 7 may be equipped with elongate holes, as a result of which a guide gap and the position of the door at the bottom can be set. The lower guide 7 ensures the guidance of the door wing or leaf 2 by virtue of its stability.

In general, the guide 7 is fixed to the coach body or vehicle by being set into the gantry floor 6. However, the features of the sliding or swinging sliding door, according to the present disclosure, can be applied to doors in which the lower guide of the door can be swung outwards. This may be the case, for example, in swinging sliding doors. The opening movement starts with a swinging-out of the lower guide and if appropriate, the upper guide, and is continued by the sliding of the door leaf 2 along the guide 7.

The guide 7, which is constructed in the form of or constructed so as to form a groove, holds the lower part of the reinforcement plate 4 and, as a result, ensures the guidance of the entire door leaf 2 during opening and closing operations of the door.

In an illustrative embodiment, the reinforcement plate 4 is bent twice along a horizontal line, with the result that the guide part 5 is offset with respect to an upper part of the reinforcement plate 4. The guide part 5 is arranged approximately centrally with respect to a cross section of the door leaf 2, with the result that the door leaf 2 rests evenly on the guide part 5. A resulting component, which integrates the reinforcement plate 4 and the guide part 5 in itself, is formed in a bent fashion in the region of the lower edge of the door leaf 2. The double-bend shape increases the stability and the rigidity of the entire structure. The reinforcement plate 4 with the integrated guide part 5 may be, for example, composed of steel or Nirosta steel.

It is within the scope of the present disclosure that the component, which integrates the reinforcement or kick plate 4 and the guide part 5 into itself in one piece, is not bent. The component could, for example, be a planar plate which engages with its lower part in the guide 7 without being bent.

It is also within the scope of the present disclosure for the guide part 5 to be bent to such an extent that it sits further outward and not precisely underneath a center of the thickness of the door wing panel or door leaf 2. It is within the scope of the present disclosure, for example, for the guide part 5 to be aligned essentially with an outer wall of the door leaf 2, as a result of which dirt cannot collect underneath the door leaf 2.

Walls of the guide 7, which are constructed as a groove, or constructed to form a groove, may be equipped with plastic walls or plastic cheeks in order to facilitate the door's guidance and to reduce noise when the door opens and closes. This buffer could alternatively also be provided on the guide part 5.

The guide part 5 does not have to be formed along an entire width of the reinforcement plate 4. It is sufficient, for example, if at least two clips, which are spaced apart from one another, project downwards into the guide 7.

Although the present disclosure has been described and illustrated in detail, it is to be clearly understood that this is done by way of illustration and example only and is not to be taken by way of limitation. The scope of the present disclosure is to be limited only by the terms of the appended claims.

I claim:

1. A sliding door or swinging sliding door for vehicles, the sliding door or swinging sliding door comprising:
a guide located in a lower region of a gantry;
a door leaf including a guide part located in a lower region of the door leaf, the guide part projecting into the guide, and the door leaf further including a reinforcement plate covering the lower region of the door leaf; and
wherein the reinforcement plate and the guide part are integrated into a single component.

2. The sliding door or swinging sliding door according to claim 1, wherein the reinforcement plate is bent around a lower edge of the door leaf, and the guide part is offset laterally with respect to an upper part of the reinforcement plate.

3. The sliding door or swinging sliding door according to claim 2, wherein the guide part is arranged, when viewed in cross section, in a direction perpendicular to a plane of the door leaf, and located essentially centrally with respect to the door leaf.
